(19) United States
(12) Patent Application Publication
(10) Pub. No.: US 2025/0048386 A1
(43) Pub. Date: Feb. 6, 2025

(54) METHOD AND DEVICE IN NODES USED FOR WIRELESS COMMUNICATION

(71) Applicants: Qi JIANG, Shanghai (CN); Xiaobo ZHANG, Shanghai (CN)

(72) Inventors: Qi JIANG, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/922,451

(22) Filed: Oct. 22, 2024

Related U.S. Application Data
(63) Continuation of application No. PCT/CN2023/091017, filed on Apr. 27, 2023.

(30) Foreign Application Priority Data
May 9, 2022 (CN) 202210499132.8

(51) Int. Cl. H04W 72/231; H04L 1/00; H04W 72/0446; H04W 72/0453

(52) U.S. Cl. CPC H04W 72/231; H04L 1/0008; H04W 72/0446; H04W 72/0453

(57) ABSTRACT

The node firstly receives a first information block, the first information block being used to indicate a DCI format monitored in a first search space; and receives a first DCI in the first search space, the first DCI using a DCI format that is a first DCI format; and then operates a first signal, the first DCI indicating the first signal; a candidate for the DCI format monitored in the first search space includes a first DCI candidate format set; whether the first DCI format is in Size Alignment with a second DCI format is related to whether the first DCI format belongs to the first DCI candidate format set; the second DCI format does not belong to the first DCI candidate format set. This application improves the criterion for size alignment between different DCI formats under multi-carrier scheduling to increase system flexibility and compatibility.

### CROSS REFERENCE TO RELATED APPLICATIONS

This application is the continuation of the international patent application No. PCT/CN2023/091017, filed on Apr. 27, 2023, and claims the priority benefit of Chinese Patent Application No. 202210499132.8, filed on May 9, 2022, the full disclosure of which is incorporated herein by reference.

### BACKGROUND

### Technical Field

The present application relates to transmission methods and devices in wireless communication systems, and in particular to a multi-carrier scheduling transmission scheme and device in wireless communications.

### Related Art

Both Long-Term Evolution (LTE) and 5G wireless cellular communication network systems support the scenario where multiple carriers are scheduled simultaneously. In the multi-carrier scheduling scenario, the base station sends multiple pieces of Downlink Control Information (multiple DCIs) to schedule Physical Downlink Shared Channels (PDSCHs) on multiple carriers to increase the transmission rate. A feature of multi-carrier scheduling is that each PDSCH requires a DCI for scheduling, and a DCI cannot simultaneously schedule multiple PDSCHs located on multiple carriers.

In the discussions of NR R17, a project based on the scheduling of Physical Downlink Shared Channel (PDSCH) or Physical Uplink Shared Channel (PUSCH) on multiple carriers with a single DCI was established, and accordingly, the solution about how to schedule the PDSCH or PUSCH on multiple carriers with a single DCI needs to be studied and discussed.

### SUMMARY

In the 5G NR system, in order to reduce the blind detection complexity of the terminal, different DCI Formats can achieve the same Payload Size by adding Padding Bits or through Truncation, which ensures that the terminal will not perform blind detection according to an excessive number of different payload sizes in a Search Space, thus reducing the complexity of terminal implementation.

In the scenario with the introduction of a single DCI scheduling multiple serving cells, since the scheduling of each serving cell is independent, the DCI format used for scheduling multiple serving cells will inevitably be different from the traditional DCI format for scheduling a single serving cell, and the payload size of the newly introduced DCI for scheduling multiple serving cells will be much larger than that of the DCI for scheduling a single serving cell, so how to improve the size alignment between multiple DCI formats will need to be reconsidered.

In view of the above scenario with multicarrier scheduling, the present application provides a solution. It should be noted that in the description of the present application, multicarrier is only used as a typical application scenario or example; the present application is also applicable to other scenarios facing similar problems, such as single-carrier scenarios with multiple BWPs (BWP as abbreviation for Bandwidth Part), or for different technical fields, such as technical fields other than dynamic scheduling, such as the field of measurement reporting, the field of control signaling and other non-dynamic scheduling fields, so as to achieve similar technical results. Additionally, the adoption of a unified solution for various scenarios, including but not limited to multi-panel scenario, contributes to the reduction of hardcore complexity and costs. In the case of no conflict, the embodiments of a first node and the characteristics in the embodiments may be applied to a second node, and vice versa. Particularly, for interpretations of the terminology, nouns, functions and variables (unless otherwise specified) in the present application, refer to definitions given in TS36 series, TS38 series and TS37 series of 3GPP specifications.

The present application provides a method in a first node for wireless communications, comprising:
receiving a first information block, the first information block being used to indicate a DCI format monitored in a first search space; and receiving a first DCI in the first search space, the first DCI using a DCI format that is a first DCI format; and
receiving a first signal, the first DCI indicating at least one of time-domain resources or frequency-domain resources occupied by the first signal;
herein, a candidate for the DCI format monitored in the first search space includes a first DCI candidate format set; whether the first DCI format is in Size Alignment with a second DCI format is related to whether the first DCI format belongs to the first DCI candidate format set; when the first DCI format belongs to the first DCI candidate format set, the first DCI format is not in Size Alignment with the second DCI format; when the first DCI format does not belong to the first DCI candidate format set, the first DCI format is in Size Alignment with the second DCI format; the second DCI format is a DCI format other than the first DCI candidate format set.

The present application provides a method in a first node for wireless communications, comprising:
receiving a first information block, the first information block being used to indicate a DCI format monitored in a first search space; and receiving a first DCI in the first search space, the first DCI using a DCI format that is a first DCI format; and
transmitting a first signal, the first DCI indicating at least one of time-domain resources or frequency-domain resources occupied by the first signal;
herein, a candidate for the DCI format monitored in the first search space includes a first DCI candidate format set; whether the first DCI format is in Size Alignment with a second DCI format is related to whether the first DCI format belongs to the first DCI candidate format set; when the first DCI format belongs to the first DCI candidate format set, the first DCI format is not in Size Alignment with the second DCI format; when the first DCI format does not belong to the first DCI candidate format set, the first DCI format is in Size Alignment with the second DCI format; the second DCI format is a DCI format other than the first DCI candidate format set.

In one embodiment, the above method is characterized in that a DCI format for scheduling multiple serving cells will not be in alignment with a DCI format for scheduling a single serving cell in terms of payload size, thereby ensuring simplicity of implementation and avoiding excessive padding bits, or avoiding the truncation of too many useful bits.

According to one aspect of the present application, characterized in that when the first DCI format belongs to the first DCI candidate format set, the first DCI format is in Size Alignment with a third DCI format, the third DCI format being a DCI candidate format in the first DCI candidate format set.

In one embodiment, the above method is characterized in that different kinds of DCI formats used for scheduling multiple serving cells are capable of payload size alignment.

According to one aspect of the present application, a target DCI format is any DCI format in the first DCI candidate format set, and the target DCI format comprises a first field; the first field in the target DCI format is used to determine L1 serving cells, L1 being a positive integer greater than 1.

According to one aspect of the present application, characterized in that the meaning of that the first DCI format is in Size Alignment with the second DCI format includes at least one of:
the first DCI format and the second DCI format being indicated by one field in a same Radio Resource Control (RRC) Information Element (IE);
the first DCI format and the second DCI format achieving identical payload sizes through padding or truncation.

According to one aspect of the present application, that the first DCI format is in Size Alignment with the third DCI format includes: the first DCI format and the third DCI format being indicated by one field in a same RRC IE.

According to one aspect of the present application, that the first DCI format is in Size Alignment with the third DCI format includes: the first DCI format and the third DCI format achieving identical payload sizes through padding or truncation.

According to one aspect of the present application, comprising:
receiving a second information block;
herein, the second information block is used to determine a second search space; the first DCI occupies one or more Physical Downlink Control Channel (PDCCH) candidates in the first search space; the second search space corresponds to a fourth DCI format; the first DCI format comprises the first field, the first field in the first DCI format being used to determine K1 serving cells, K1 being a positive integer greater than 1; the fourth DCI format comprises the first field, the first field in the fourth DCI format being used to determine K4 serving cell(s), K4 being a positive integer; the first DCI format belongs to the first DCI candidate format set; the K1 being greater than the K4 is used to determine that the first node cancels monitoring of a PDCCH in the second search space.

According to one aspect of the present application, the frequency-domain resources occupied by the first signal are associated to at least two serving cells.

According to one aspect of the present application, the first signal is generated by M1 bit blocks, M1 being a positive integer greater than 1, the M1 bit blocks respectively occupying M1 HARQ process numbers.

According to one aspect of the present application, the first information block comprises first information, the first information being a Sequence, the first information comprised in the first information block indicating a DCI format that is capable of size alignment in the first search space.

According to one aspect of the present application, the first information block comprises second information, the second information being Enumerated, the second information comprised in the first information block indicating a DCI format that is capable of size alignment in the first search space.

The present application provides a method in a second node for wireless communications, comprising:
transmitting a first information block, the first information block being used to indicate a DCI format monitored in a first search space; and transmitting a first DCI in the first search space, the first DCI using a DCI format that is a first DCI format; and
transmitting a first signal, the first DCI indicating at least one of time-domain resources or frequency-domain resources occupied by the first signal;
herein, a candidate for the DCI format monitored in the first search space includes a first DCI candidate format set; whether the first DCI format is in Size Alignment with a second DCI format is related to whether the first DCI format belongs to the first DCI candidate format set; when the first DCI format belongs to the first DCI candidate format set, the first DCI format is not in Size Alignment with the second DCI format; when the first DCI format does not belong to the first DCI candidate format set, the first DCI format is in Size Alignment with the second DCI format; the second DCI format is a DCI format other than the first DCI candidate format set.

The present application provides a method in a second node for wireless communications, comprising:
transmitting a first information block, the first information block being used to indicate a DCI format monitored in a first search space; and transmitting a first DCI in the first search space, the first DCI using a DCI format that is a first DCI format; and
receiving a first signal, the first DCI indicating at least one of time-domain resources or frequency-domain resources occupied by the first signal;
herein, a candidate for the DCI format monitored in the first search space includes a first DCI candidate format set; whether the first DCI format is in Size Alignment with a second DCI format is related to whether the first DCI format belongs to the first DCI candidate format set; when the first DCI format belongs to the first DCI candidate format set, the first DCI format is not in Size Alignment with the second DCI format; when the first DCI format does not belong to the first DCI candidate format set, the first DCI format is in Size Alignment with the second DCI format; the second DCI format is a DCI format other than the first DCI candidate format set.

According to one aspect of the present application, when the first DCI format belongs to the first DCI candidate format set, the first DCI format is in Size Alignment with a third DCI format, the third DCI format being a DCI candidate format in the first DCI candidate format set.

According to one aspect of the present application, a target DCI format is any DCI format in the first DCI candidate format set, and the target DCI format comprises a first field; the first field in the target DCI format is used to determine L1 serving cells, L1 being a positive integer greater than 1.

According to one aspect of the present application, characterized in that the meaning of that the first DCI format is in Size Alignment with the second DCI format includes at least one of:
the first DCI format and the second DCI format being indicated by one field in a same RRC IE; or
the first DCI format and the second DCI format achieving identical payload sizes through padding or truncation.

According to one aspect of the present application, that the first DCI format is in Size Alignment with the third DCI format includes: the first DCI format and the third DCI format being indicated by one field in a same RRC IE.

According to one aspect of the present application, that the first DCI format is in Size Alignment with the third DCI format includes: the first DCI format and the third DCI format achieving identical payload sizes through padding or truncation.

According to one aspect of the present application, comprising:
transmitting a second information block;
herein, the second information block is used to determine a second search space; the first DCI occupies one or more PDCCH candidates in the first search space; the second search space corresponds to a fourth DCI format; the first DCI format comprises the first field, the first field in the first DCI format being used to determine K1 serving cells, K1 being a positive integer greater than 1; the fourth DCI format comprises the first field, the first field in the fourth DCI format being used to determine K4 serving cell(s), K4 being a positive integer; the first DCI format belongs to the first DCI candidate format set; the K1 being greater than the K4 is used to determine that the first node cancels monitoring of a PDCCH in the second search space.

According to one aspect of the present application, the frequency-domain resources occupied by the first signal are associated to at least two serving cells.

According to one aspect of the present application, the first signal is generated by M1 bit blocks, M1 being a positive integer greater than 1, the M1 bit blocks respectively occupying M1 HARQ process numbers.

According to one aspect of the present application, the first information block comprises first information, the first information being a Sequence, the first information comprised in the first information block indicating a DCI format that is capable of size alignment in the first search space.

According to one aspect of the present application, the first information block comprises second information, the second information being Enumerated, the second information comprised in the first information block indicating a DCI format that is capable of size alignment in the first search space.

The present application provides a first node for wireless communications, comprising:
a first receiver, receiving a first information block, the first information block being used to indicate a DCI format monitored in a first search space; and receiving a first DCI in the first search space, the first DCI using a DCI format that is a first DCI format; and
a first transceiver, receiving a first signal, the first DCI indicating at least one of time-domain resources or frequency-domain resources occupied by the first signal;
herein, a candidate for the DCI format monitored in the first search space includes a first DCI candidate format set; whether the first DCI format is in Size Alignment with a second DCI format is related to whether the first DCI format belongs to the first DCI candidate format set; when the first DCI format belongs to the first DCI candidate format set, the first DCI format is not in Size Alignment with the second DCI format; when the first DCI format does not belong to the first DCI candidate format set, the first DCI format is in Size Alignment with the second DCI format; the second DCI format is a DCI format other than the first DCI candidate format set.

The present application provides a first node for wireless communications, comprising:
a first receiver, receiving a first information block, the first information block being used to indicate a DCI format monitored in a first search space; and receiving a first DCI in the first search space, the first DCI using a DCI format that is a first DCI format; and
a first transceiver, transmitting a first signal, the first DCI indicating at least one of time-domain resources or frequency-domain resources occupied by the first signal;
herein, a candidate for the DCI format monitored in the first search space includes a first DCI candidate format set; whether the first DCI format is in Size Alignment with a second DCI format is related to whether the first DCI format belongs to the first DCI candidate format set; when the first DCI format belongs to the first DCI candidate format set, the first DCI format is not in Size Alignment with the second DCI format; when the first DCI format does not belong to the first DCI candidate format set, the first DCI format is in Size Alignment with the second DCI format; the second DCI format is a DCI format other than the first DCI candidate format set.

The present application provides a second node for wireless communications, comprising:
a first transmitter, transmitting a first information block, the first information block being used to indicate a DCI format monitored in a first search space; and transmitting a first DCI in the first search space, the first DCI using a DCI format that is a first DCI format; and
a second transceiver, transmitting a first signal, the first DCI indicating at least one of time-domain resources or frequency-domain resources occupied by the first signal;
herein, a candidate for the DCI format monitored in the first search space includes a first DCI candidate format set; whether the first DCI format is in Size Alignment with a second DCI format is related to whether the first DCI format belongs to the first DCI candidate format set; when the first DCI format belongs to the first DCI candidate format set, the first DCI format is not in Size Alignment with the second DCI format; when the first DCI format does not belong to the first DCI candidate format set, the first DCI format is in Size Alignment with the second DCI format; the second DCI format is a DCI format other than the first DCI candidate format set.

The present application provides a second node for wireless communications, comprising:
a first transmitter, transmitting a first information block, the first information block being used to indicate a DCI format monitored in a first search space; and transmitting a first DCI in the first search space, the first DCI using a DCI format that is a first DCI format; and
a second transceiver, receiving a first signal, the first DCI indicating at least one of time-domain resources or frequency-domain resources occupied by the first signal;
herein, a candidate for the DCI format monitored in the first search space includes a first DCI candidate format set; whether the first DCI format is in Size Alignment with a second DCI format is related to whether the first DCI format belongs to the first DCI candidate format set; when the first DCI format belongs to the first DCI candidate format set, the first DCI format is not in Size Alignment with the second DCI format; when the first DCI format does not belong to the first DCI candidate format set, the first DCI format is in Size Alignment with the second DCI format; the second DCI format is a DCI format other than the first DCI candidate format set.

In one embodiment, the scheme in the present application is advantageous in improving the criterion for size alignment of DCI formats supporting the scheduling of multiple serving cells with single DCI to optimize system design and improve system performance.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of processing of a first node according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of a first information block according to one embodiment of the present application.

FIG. 6 illustrates a flowchart of a first signal according to one embodiment of the present application.

FIG. 7 illustrates a flowchart of a second information block according to one embodiment of the present application.

FIG. 8 illustrates a schematic diagram of a first information block according to one embodiment of the present application.

FIG. 9 illustrates a schematic diagram of a first search space and a second search space according to one embodiment of the present application.

FIG. 10 illustrates a schematic diagram of DCI Size Alignment according to one embodiment of the present application.

FIG. 11 illustrates a schematic diagram of DCI Size Alignment according to another embodiment of the present application.

FIG. 12 illustrates a structure block diagram of a processing device in a first node according to one embodiment of the present application.

FIG. 13 illustrates a structure block diagram of a processing device in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

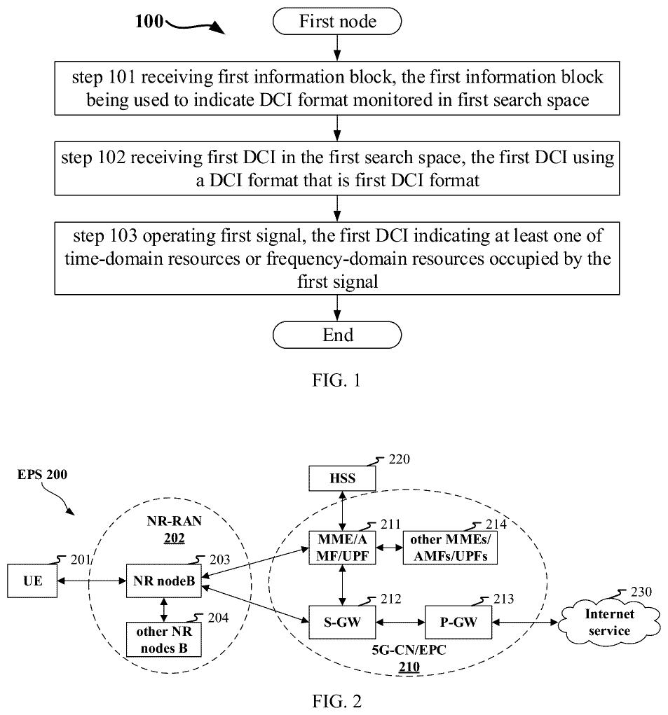

Embodiment 1 illustrates a flowchart of processing of a first node, as shown in FIG. 1. In 100 illustrated by FIG. 1, each box represents a step. In Embodiment 1, the first node of this application receives a first information block in step 101, the first information block being used to indicate a DCI format monitored in a first search space; and receives a first DCI in the first search space in step 102, the first DCI using a DCI format that is a first DCI format; and operates a first signal in step 103, the first DCI indicating at least one of time-domain resources or frequency-domain resources occupied by the first signal.

In Embodiment 1, the operating is receiving, or the operating is transmitting; a candidate for the DCI format monitored in the first search space includes a first DCI candidate format set; whether the first DCI format is in Size Alignment with a second DCI format is related to whether the first DCI format belongs to the first DCI candidate format set; when the first DCI format belongs to the first DCI candidate format set, the first DCI format is not in Size Alignment with the second DCI format; when the first DCI format does not belong to the first DCI candidate format set, the first DCI format is in Size Alignment with the second DCI format; the second DCI format is a DCI format other than the first DCI candidate format set.

In one embodiment, the first information block comprises an RRC signaling.

In one embodiment, the first information block is transmitted through an RRC signaling.

In one embodiment, the RRC signaling corresponding to the first information block comprises a SearchSpace IE in TS 38.331.

In one embodiment, the first information block comprises one or more fields in the RRC signaling SearchSpace IE.

In one embodiment, a name of the RRC signaling corresponding to the first information block includes SearchSpace.

In one embodiment, a name of the RRC signaling corresponding to the first information block includes Multi.

In one embodiment, a name of the RRC signaling corresponding to the first information block includes Cells.

In one embodiment, a name of the RRC signaling corresponding to the first information block includes Cross.

In one embodiment, a name of the RRC signaling corresponding to the first information block includes Carrier.

In one embodiment, the first search space comprises a Search Space.

In one embodiment, the first search space comprises a Search Space Set.

In one embodiment, the first search space corresponds to a Control Resource Set (CORESET).

In one embodiment, the first information block is used to indicate multiple DCI formats monitored in the first search space.

In one embodiment, a physical layer channel occupied by the first DCI includes a PDCCH.

In one embodiment, a physical layer channel corresponding to the first DCI includes a PDCCH.

In one embodiment, the first DCI format includes DCI format X_0.

In one embodiment, the first DCI format includes DCI format X_1.

In one subembodiment, X is a positive integer greater than 3.

In one subembodiment, X is equal to 4.

In one subembodiment, X is equal to 5.

In one embodiment, the operating is receiving, and the physical layer channel occupied by the first signal comprises one or more Physical Downlink Shared Channels (PDSCHs).

In one embodiment, the operating is transmitting, and the physical layer channel occupied by the first signal comprises one or more Physical Uplink Shared Channels (PUSCHs).

In one embodiment, the operating is receiving, and the transport channel corresponding to the first signal comprises one or more Downlink Shared Channels (DL-SCHs).

In one embodiment, the operating is transmitting, and the transport channel corresponding to the first signal comprises one or more Uplink Shared Channels (UL-SCHs).

In one embodiment, the first DCI indicates the time-domain resources occupied by the first signal.

In one embodiment, the first DCI indicates the frequency-domain resources occupied by the first signal.

In one embodiment, the first DCI indicates a Modulation and Coding Scheme (MCS) employed by the first signal.

In one embodiment, the first DCI indicates a Transmission Configuration Indication (TCI) corresponding to the first signal.

In one embodiment, the first signal comprises K1 sub-signals, and the K1 sub-signals are respectively transmitted on K1 serving cells, the first DCI being used to indicate the K1 serving cells.

In one subembodiment, the first DCI comprises K1 fields, the K1 fields respectively corresponding to the K1 sub-signals.

In one subsidiary embodiment of the above subembodiment, the K1 fields respectively indicate K1 time-domain resources occupied by the K1 sub-signals.

In one subsidiary embodiment of the above subembodiment, the K1 fields respectively indicate K1 frequency-domain resources occupied by the K1 sub-signals.

In one subsidiary embodiment of the above subembodiment, the K1 fields respectively indicate K1 MCSs employed by the K1 sub-signals.

In one subsidiary embodiment of the above subembodiment, the K1 fields respectively indicate K1 Hybrid Automatic Repeat reQuest (HARQ) process numbers occupied by the K1 sub-signals.

In one subsidiary embodiment of the above subembodiment, the K1 fields respectively indicate K1 Redundancy Versions (RV) employed by the K1 sub-signals.

In one subsidiary embodiment of the above subembodiment, the K1 fields respectively indicate K1 TCIs employed by the K1 sub-signals.

In one embodiment, the first DCI candidate format set includes Q1 DCI formats, and at least one of the Q1 DCI formats is used to indicate multiple serving cells.

In one embodiment, the first DCI candidate format set includes Q1 DCI formats, and any one of the Q1 DCI formats is used to indicate multiple serving cells.

In one embodiment, when the first DCI format belongs to the first DCI candidate format set, the first DCI format is not in Size Alignment with the second DCI format.

In one embodiment, when the first DCI format does not belong to the first DCI candidate format set, the first DCI format is in Size Alignment with the second DCI format.

In one embodiment, the first DCI candidate format set is used for single DCI multi-cell scheduling.

In one embodiment, the operating is receiving, and the second DCI format is used for scheduling of PUSCH.

In one embodiment, the operating is transmitting, and the second DCI format is used for scheduling of PDSCH.

In one embodiment, the second DCI format is used to schedule one cell, and any DCI format in the first DCI candidate format set is used to schedule multiple cells.

In one embodiment, the candidate for the DCI format monitored in the first search space includes the second DCI format.

Typically, the first information block comprises first information, the first information being a Sequence, the first information comprised in the first information block indicating a DCI format that is capable of size alignment in the first search space.

In one subembodiment, the name of the first information includes ue-specific.

Typically, the first information block comprises second information, the second information being Enumerated, the second information comprised in the first information block indicating a DCI format that is capable of size alignment in the first search space.

In one subembodiment, the name of the second information includes dci-FormatsExt-r18.

In one subembodiment, the name of the second information includes dci-Formats-r18.

In one subembodiment, the name of the second information includes dci-Formats-MultiCell.

In one subembodiment, the first DCI format belongs to the first DCI candidate format set, and the second information indicates that the first DCI format is capable of size alignment with a DCI format other than the first DCI format in the first DCI candidate format set.

In one embodiment, the first search space comprises X1 PDCCH candidates, X1 being a positive integer greater than 1.

In one subembodiment, the first DCI occupies one PDCCH candidate of the X1 PDCCH candidates included in the first search space.

In one subembodiment, the first DCI occupies multiple PDCCH candidates among the X1 PDCCH candidates included in the first search space.

In one embodiment, the serving cell in this application corresponds to one carrier.

In one embodiment, the serving cell in this application corresponds to a Component Carrier (CC).

### Embodiment 2

Embodiment 2 illustrates a schematic diagram of a network architecture, as shown in FIG. 2.

FIG. 2 is a diagram illustrating a network architecture 200 of 5G NR, Long-Term Evolution (LTE) and Long-Term Evolution Advanced (LTE-A) systems. The 5G NR or LTE network architecture 200 may be called an Evolved Packet System (EPS) 200 or other suitable terminology. The EPS 200 may comprise one UE 201, an NR-RAN 202, a Evolved Packet Core (EPC)/5G-Core Network (5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will find it easy to understand that various concepts presented throughout the present application can be extended to networks providing circuit switching services or other cellular networks. The NR-RAN 202 comprises an NR node B (gNB) 203 and other gNBs 204. The gNB 203 provides UE 201 oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/Authentication Management Field (AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212. The S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE 201 corresponds to the first node in the present application.

In one embodiment, the UE 201 supports multiple carriers being scheduled by a same DCI.

In one embodiment, the UE 201 supports multiple serving cells being scheduled by a same DCI.

In one embodiment, the UE 201 supports cross-carrier scheduling.

In one embodiment, the NR node B corresponds to the second node in the present application.

In one embodiment, the NR node B supports multiple carriers being scheduled by a same DCI.

In one embodiment, the NR node B supports multiple serving cells being scheduled by a same DCI.

In one embodiment, the NR node B supports cross-carrier scheduling.

In one embodiment, the NR node B is a base station.

In one embodiment, the NR node B is a cell.

In one embodiment, the NR node B comprises multiple cells.

In one embodiment, the NR node B is used to determine transmissions on multiple serving cells.

In one embodiment, the first node in the present application corresponds to the UE 201, and the second node in the present application corresponds to the NR node B.

### Embodiment 3

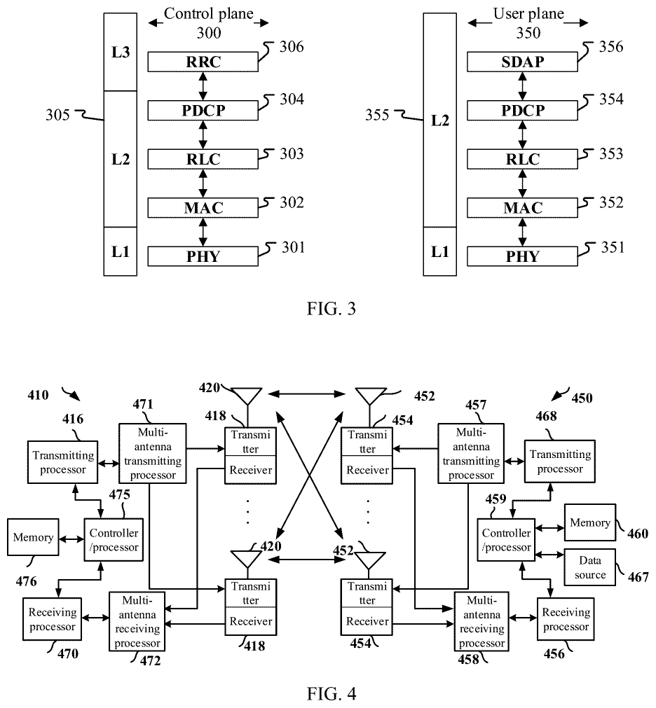

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first communication node (UE, gNB or, RSU in V2X) and a second communication node (gNB, UE, or RSU in V2X), is represented by three layers, i.e., layer 1, layer 2 and layer 3. The layer 1 (L1) is the lowest layer which performs signal processing functions of various PHY layers. The L1 is called PHY 301 in the present application. The layer 2 (L2) 305 is above the PHY 301, and is in charge of the link between a first communication node and a second communication node via the PHY 301. The L2 305 comprises a Medium Access Control (MAC) sublayer 302, a Radio Link Control (RLC) sublayer 303 and a Packet Data Convergence Protocol (PDCP) sublayer 304. All these sublayers terminate at the second communication nodes. The PDCP sublayer 304 provides multiplexing among variable radio bearers and logical channels. The PDCP sublayer 304 provides security by encrypting packets and also support for inter-cell handover of the second communication node between first communication nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling between the second communication node and the first communication node. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first communication node may comprise several higher layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the PDCP 304 of the second communication node is used for generating scheduling of the first communication node.

In one embodiment, the PDCP 354 of the second communication node is used for generating scheduling of the first communication node.

In one embodiment, the first information block is generated by the MAC 302 or the MAC 352.

In one embodiment, the first information block is generated by the RRC 306.

In one embodiment, the first DCI is generated by the PHY 301 or the PHY 351.

In one embodiment, the first DCI is generated by the MAC 302 or the MAC 352.

In one embodiment, the first signal is generated by the PHY 301 or the PHY 351.

In one embodiment, the first signal is generated by the MAC 302 or the MAC 352.

In one embodiment, the first signal is generated by the RRC 306.

In one embodiment, the second information block is generated by the MAC 302 or the MAC 352.

In one embodiment, the second information block is generated by the RRC 306.

In one embodiment, the first node is a terminal.

In one embodiment, the first node is a relay.

In one embodiment, the second node is a relay.

In one embodiment, the second node is a base station.

In one embodiment, the second node is a gNB.

In one embodiment, the second node is a Transmitter Receiver Point (TRP).

In one embodiment, the second node is used for managing multiple TRPs.

In one embodiment, the second node is used for managing multiple nodes of cells.

In one embodiment, the second node is used for managing multiple nodes of serving cells.

### Embodiment 4

Embodiment 4 illustrates a schematic diagram of a first communication device and a second communication device according to the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network is provided to the controller/processor 475. The controller/processor 475 provides functions of the L2 layer. In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also in charge of a retransmission of a lost packet and a signaling to the first communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 410 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any first communication device 450-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with the memory 460 that stores program code and data; the memory 460 may be called a computer readable medium. In the transmission from the second communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication node 410 to the first communication node 450, the controller/processor 459 performs header compression, encryption, packet segmentation and reordering, and multiplexing between a logical channel and a transport channel based on radio resource allocation so as to provide the L2 layer functions used for the user plane and the control plane. The controller/processor 459 is also responsible for a retransmission of a lost packet, and a signaling to the second communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data; the memory 476 may be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device (UE) 450. The higher-layer packet coming from the controller/processor 475 may be provided to the core network.

In one embodiment, the first communication device 450 comprises at least one processor and at least one memory. The at least one memory comprises computer program codes; the at least one memory and the computer program codes are configured to be used in collaboration with the at least one processor. The first communication device 450 at least firstly receives a first information block, the first information block being used to indicate a DCI format monitored in a first search space; and then receives a first DCI in the first search space, the first DCI using a DCI format that is a first DCI format; and after that operates a first signal, the first DCI indicating at least one of time-domain resources or frequency-domain resources occupied by the first signal; the operating is receiving, or the operating is transmitting; a candidate for the DCI format monitored in the first search space includes a first DCI candidate format set, whether the first DCI format is in Size Alignment with a second DCI format is related to whether the first DCI format belongs to the first DCI candidate format set; when the first DCI format belongs to the first DCI candidate format set, the first DCI format is not in Size Alignment with the second DCI format; when the first DCI format does not belong to the first DCI candidate format set, the first DCI format is in Size Alignment with the second DCI format; the second DCI format is a DCI format other than the first DCI candidate format set.

In one embodiment, the first communication device 450 comprises a memory that stores a computer readable instruction program. The computer readable instruction program generates actions when executed by at least one processor. The actions include: firstly receiving a first information block, the first information block being used to indicate a DCI format monitored in a first search space; and then receiving a first DCI in the first search space, the first DCI using a DCI format that is a first DCI format; and after that operating a first signal, the first DCI indicating at least one of time-domain resources or frequency-domain resources occupied by the first signal; the operating is receiving, or the operating is transmitting; a candidate for the DCI format monitored in the first search space includes a first DCI candidate format set; whether the first DCI format is in Size Alignment with a second DCI format is related to whether the first DCI format belongs to the first DCI candidate format set; when the first DCI format belongs to the first DCI candidate format set, the first DCI format is not in Size Alignment with the second DCI format; when the first DCI format does not belong to the first DCI candidate format set, the first DCI format is in Size Alignment with the second DCI format; the second DCI format is a DCI format other than the first DCI candidate format set.

In one embodiment, the second communication device 410 comprises at least one processor and at least one memory. The at least one memory comprises computer program codes; the at least one memory and the computer program codes are configured to be used in collaboration with the at least one processor. The second communication device 410 at least firstly transmits a first information block, the first information block being used to indicate a DCI format monitored in a first search space; and then transmits a first DCI in the first search space, the first DCI using a DCI format that is a first DCI format; and after that executes a first signal, the first DCI indicating at least one of time-domain resources or frequency-domain resources occupied by the first signal; the executing is transmitting, or the executing is receiving; a candidate for the DCI format monitored in the first search space includes a first DCI candidate format set; whether the first DCI format is in Size Alignment with a second DCI format is related to whether the first DCI format belongs to the first DCI candidate format set; when the first DCI format belongs to the first DCI candidate format set, the first DCI format is not in Size Alignment with the second DCI format; when the first DCI format does not belong to the first DCI candidate format set, the first DCI format is in Size Alignment with the second DCI format; the second DCI format is a DCI format other than the first DCI candidate format set.

In one embodiment, the second communication device 410 comprises a memory that stores a computer readable instruction program. The computer readable instruction program generates actions when executed by at least one processor. The actions include: firstly transmitting a first information block, the first information block being used to indicate a DCI format monitored in a first search space; and then transmitting a first DCI in the first search space, the first DCI using a DCI format that is a first DCI format; and after that executing a first signal, the first DCI indicating at least one of time-domain resources or frequency-domain resources occupied by the first signal; the executing is transmitting, or the executing is receiving; a candidate for the DCI format monitored in the first search space includes a first DCI candidate format set; whether the first DCI format is in Size Alignment with a second DCI format is related to whether the first DCI format belongs to the first DCI candidate format set; when the first DCI format belongs to the first DCI candidate format set, the first DCI format is not in Size Alignment with the second DCI format; when the first DCI format does not belong to the first DCI candidate format set, the first DCI format is in Size Alignment with the second DCI format; the second DCI format is a DCI format other than the first DCI candidate format set.

In one embodiment, the first communication device 450 corresponds to the first node in the present application.

In one embodiment, the second communication device 410 corresponds to the second node in the present application.

In one embodiment, the first communication device 450 is a UE.

In one embodiment, the first communication device 450 is a terminal.

In one embodiment, the first communication device 450 is a relay.

In one embodiment, the second communication device 410 is a base station.

In one embodiment, the second communication device 410 is a relay.

In one embodiment, the second communication device 410 is network equipment.

In one embodiment, the second communication device 410 is a serving cell.

In one embodiment, the second communication device 410 is a TRP.

In one embodiment, at least the first four of the antenna 452, the receiver 454, the multi-antenna receiving processor 458, the receiving processor 456, and the controller/processor 459 are used for receiving a first information block; at least the first four of the antenna 420, the transmitter 418, the multi-antenna transmitting processor 471, the transmitting processor 416 and the controller/processor 475 are used for transmitting a first information block.

In one embodiment, at least the first four of the antenna 452, the receiver 454, the multi-antenna receiving processor 458, the receiving processor 456, and the controller/processor 459 are used to receive a first DCI in a first search space; at least the first four of the antenna 420, the transmitter 418, the multi-antenna transmitting processor 471, the transmitting processor 416 and the controller/processor 475 are used to transmit a first DCI in a first search space.

In one embodiment, at least the first four of the antenna 452, the receiver 454, the multi-antenna receiving processor 458, the receiving processor 456, and the controller/processor 459 are used for receiving a first signal; at least the first four of the antenna 420, the transmitter 418, the multi-antenna transmitting processor 471, the transmitting processor 416 and the controller/processor 475 are used for transmitting a first signal.

In one embodiment, at least the first four of the antenna 452, the transmitter 454, the multi-antenna transmitting processor 457, the transmitting processor 468 and the controller/processor 459 are used to transmit a first signal; at least the first four of the antenna 420, the receiver 418, the multi-antenna receiving processor 472, the receiving processor 470 and the controller/processor 475 are used to receive a first signal.

In one embodiment, at least the first four of the antenna 452, the receiver 454, the multi-antenna receiving processor 458, the receiving processor 456, and the controller/processor 459 are used for receiving a second information block; at least the first four of the antenna 420, the transmitter 418, the multi-antenna transmitting processor 471, the transmitting processor 416 and the controller/processor 475 are used for transmitting a second information block.

### Embodiment 5

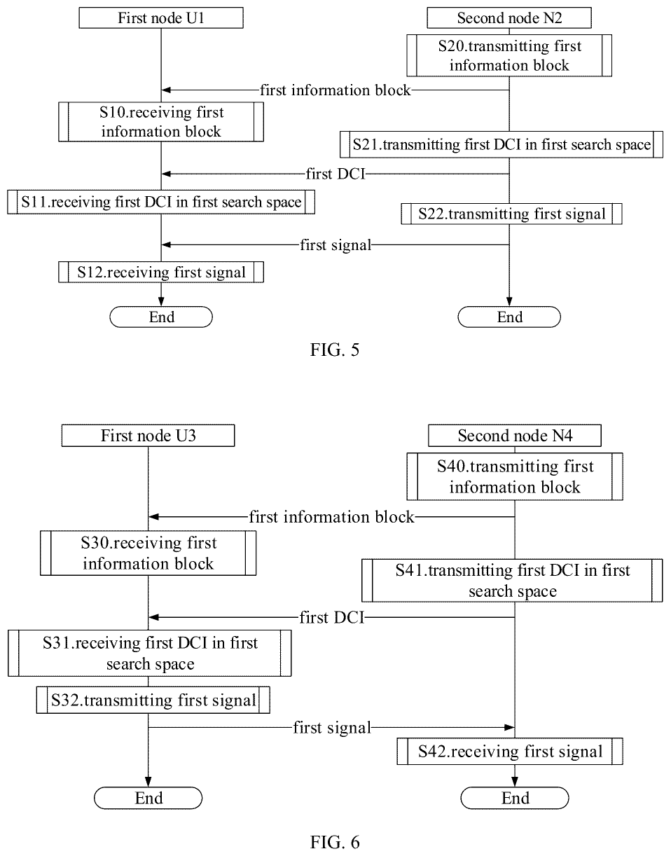

Embodiment 5 illustrates a flowchart of a first information block, as shown in FIG. 5. In FIG. 5, a first node U1 and a second node N2 are in communication via a radio link. It should be particularly noted that the sequence illustrated herein does not set any limit to the signal transmission order or implementation order in the present application. In case of no conflict, the embodiments, sub-embodiments, and subsidiary embodiments in Embodiment 5 can be applied to any of Embodiments 6 or 7; conversely, in case of no conflict, the embodiments, sub-embodiments, and subsidiary embodiments in any of Embodiments 6 or 7 can be applied to Embodiment 5.

The first node U1 receives a first information block in step S10; and receives a first DCI in a first search space in step S11; and receives a first signal in step S12.

The second node N2 transmits a first information block in step S20; and transmits a first DCI in a first search space in step S21; and transmits a first signal in step S22.

In Embodiment 5, the first information block is used to indicate a DCI format monitored in the first search space; and the first DCI uses a DCI format that is a first DCI format; and the first DCI indicates at least one of time-domain resources or frequency-domain resources occupied by the first signal; the operating is receiving, or the operating is transmitting; a candidate for the DCI format monitored in the first search space includes a first DCI candidate format set; whether the first DCI format is in Size Alignment with a second DCI format is related to whether the first DCI format belongs to the first DCI candidate format set; when the first DCI format belongs to the first DCI candidate format set, the first DCI format is not in Size Alignment with the second DCI format; when the first DCI format does not belong to the first DCI candidate format set, the first DCI format is in Size Alignment with the second DCI format; the second DCI format is a DCI format other than the first DCI candidate format set.

Typically, when the first DCI format belongs to the first DCI candidate format set, the first DCI format is in Size Alignment with a third DCI format, the third DCI format being a DCI candidate format in the first DCI candidate format set.

In one embodiment, the second DCI format is used to schedule one cell, and any DCI format in the first DCI candidate format set is used to schedule up to N1 cells, N1 being a positive integer greater than 1.

In one embodiment, different DCI candidate formats in the first DCI candidate format set correspond to different values of the N1.

In one embodiment, the N1 is configurable.

In one embodiment, the third DCI format is used to schedule multiple serving cells.

In one embodiment, the first DCI format is used for downlink scheduling and the third DCI format is used for uplink scheduling.

In one embodiment, the first DCI format is used for uplink scheduling and the third DCI format is used for downlink scheduling.

In one embodiment, the first DCI format is used for downlink scheduling and the third DCI format is used for downlink scheduling.

In one embodiment, the first DCI format is used for uplink scheduling and the third DCI format is used for uplink scheduling.

In one embodiment, the third DCI format is a Fallback of the first DCI format.

In one embodiment, the first DCI format has a different Payload size than the third DCI format.

Typically, a target DCI format is any DCI format in the first DCI candidate format set, and the target DCI format comprises a first field; the first field in the target DCI format is used to determine L1 serving cells, L1 being a positive integer greater than 1.

In one embodiment, the first field is used to indicate the L1 serving cells.

In one embodiment, the value of L1 is configured by RRC signaling.

In one embodiment, the first DCI candidate format set includes at least two DCI formats, the two DCI formats indicating different numbers of serving cells.

In one embodiment, the first field included in the target DCI is a Multi-Cell Indicator Field (MIF).

In one embodiment, the first field included in the target DCI is a Multi-Cell Cross Carrier Indicator Field (MCIF).

Typically, the meaning of that the first DCI format is in Size Alignment with the second DCI format includes at least one of:
the first DCI format and the second DCI format being indicated by one field in a same RRC IE; or
the first DCI format and the second DCI format achieving identical payload sizes through padding or truncation.

In one embodiment, the payload size of the first DCI format is larger than the payload size of the second DCI format, and the first DCI format achieves the same payload size as the second DCI format through truncation.

In one embodiment, the payload size of the first DCI format is larger than the payload size of the second DCI format, and the second DCI format achieves the same payload size as the first DCI format through padding bits.

In one embodiment, the payload size of the first DCI format is smaller than the payload size of the second DCI format, and the first DCI format achieves the same payload size as the second DCI format through padding bits.

In one embodiment, the payload size of the first DCI format is smaller than the payload size of the second DCI format, and the second DCI format achieves the same payload size as the first DCI format through truncation.

Typically, that the first DCI format is in Size Alignment with the third DCI format includes: the first DCI format and the third DCI format being indicated by one field in a same RRC IE.

Typically, that the first DCI format is in Size Alignment with the third DCI format includes: the first DCI format and the third DCI format achieving identical payload sizes through padding or truncation.

In one embodiment, the payload size of the first DCI format is larger than the payload size of the third DCI format, and the first DCI format achieves the same payload size as the third DCI format through truncation.

In one embodiment, the payload size of the first DCI format is larger than the payload size of the third DCI format, and the third DCI format achieves the same payload size as the first DCI format through padding bits.

In one embodiment, the payload size of the first DCI format is smaller than the payload size of the third DCI format, and the first DCI format achieves the same payload size as the third DCI format through padding bits.

In one embodiment, the payload size of the first DCI format is smaller than the payload size of the third DCI format, and the third DCI format achieves the same payload size as the first DCI format through truncation.

Typically, the frequency-domain resources occupied by the first signal are associated to at least two serving cells.

Typically, the first signal is generated by M1 bit blocks, M1 being a positive integer greater than 1, the M1 bit blocks respectively occupying M1 HARQ process numbers.

### Embodiment 6

Embodiment 6 illustrates a flowchart of a first signal, as shown in FIG. 6. In FIG. 6, a first node U3 and a second node N4 are in communication via a radio link. It should be particularly noted that the sequence illustrated herein does not set any limit to the signal transmission order or implementation order in the present application. In case of no conflict, the embodiments, sub-embodiments, and subsidiary embodiments in Embodiment 6 can be applied to any of Embodiments 5 or 7; conversely, in case of no conflict, the embodiments, sub-embodiments, and subsidiary embodiments in any of Embodiments 5 or 7 can be applied to Embodiment 6.

The first node U3 receives a first information block in step S30; and receives a first DCI in a first search space in step S31; and transmits a first signal in step S32.

The second node N4 transmits a first information block in step S40; and transmits a first DCI in a first search space in step S41; and receives a first signal in step S42.

In Embodiment 6, the first information block is used to indicate a DCI format monitored in the first search space; and the first DCI uses a DCI format that is a first DCI format; and the first DCI indicates at least one of time-domain resources or frequency-domain resources occupied by the first signal; the operating is receiving, or the operating is transmitting; a candidate for the DCI format monitored in the first search space includes a first DCI candidate format set; whether the first DCI format is in Size Alignment with a second DCI format is related to whether the first DCI format belongs to the first DCI candidate format set; when the first DCI format belongs to the first DCI candidate format set, the first DCI format is not in Size Alignment with the second DCI format; when the first DCI format does not belong to the first DCI candidate format set, the first DCI format is in Size Alignment with the second DCI format; the second DCI format is a DCI format other than the first DCI candidate format set.

Typically, when the first DCI format belongs to the first DCI candidate format set, the first DCI format is in Size Alignment with a third DCI format, the third DCI format being a DCI candidate format in the first DCI candidate format set.

Typically, a target DCI format is any DCI format in the first DCI candidate format set, and the target DCI format comprises a first field; the first field in the target DCI format is used to determine L1 serving cells, L1 being a positive integer greater than 1.

Typically, the meaning of that the first DCI format is in Size Alignment with the second DCI format includes at least one of:
the first DCI format and the second DCI format being indicated by one field in a same RRC IE; or
the first DCI format and the second DCI format achieving identical payload sizes through padding or truncation.

Typically, that the first DCI format is in Size Alignment with the third DCI format includes: the first DCI format and the third DCI format being indicated by one field in a same RRC IE.

Typically, that the first DCI format is in Size Alignment with the third DCI format includes: the first DCI format and the third DCI format achieving identical payload sizes through padding or truncation.

Typically, the frequency-domain resources occupied by the first signal are associated to at least two serving cells.

Typically, the first signal is generated by M1 bit blocks, M1 being a positive integer greater than 1, the M1 bit blocks respectively occupying MI HARQ process numbers.

### Embodiment 7

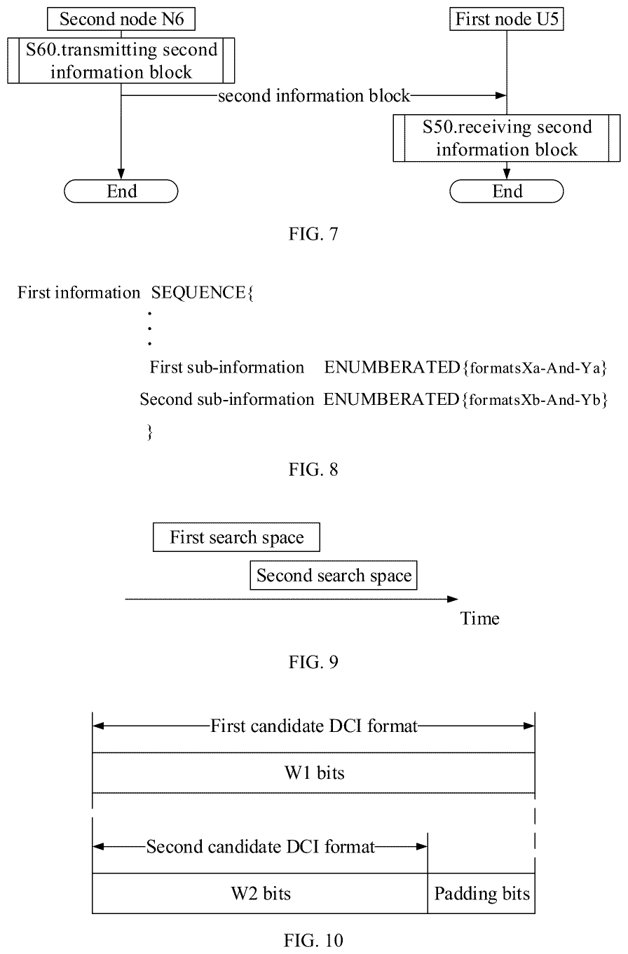

Embodiment 7 illustrates a flowchart of a second information block, as shown in FIG. 7. In FIG. 7, a first node U5 and a second node N6 are in communication via a radio link. It should be particularly noted that the sequence illustrated herein does not set any limit to the signal transmission order or implementation order in the present application. In case of no conflict, the embodiments, sub-embodiments, and subsidiary embodiments in Embodiment 7 can be applied to any of Embodiments 5 or 6; conversely, in case of no conflict, the embodiments, sub-embodiments, and subsidiary embodiments in any of Embodiments 5 or 6 can be applied to Embodiment 7.

The first node U5 receives a second information block in step S50.

The second node N6 transmits the second information block in step S60.

In Embodiment 7, the second information block is used to determine a second search space; the first DCI occupies one or more PDCCH candidates in the first search space; the second search space corresponds to a fourth DCI format; the first DCI format comprises the first field, the first field in the first DCI format being used to determine K1 serving cells, K1 being a positive integer greater than 1; the fourth DCI format comprises the first field, the first field in the fourth DCI format being used to determine K4 serving cell(s), K4 being a positive integer; the first DCI format belongs to the first DCI candidate format set; the K1 being greater than the K4 is used to determine that the first node cancels monitoring of a PDCCH in the second search space.

In one embodiment, the second information block comprises an RRC signaling.

In one embodiment, the second information block is transmitted through an RRC signaling.

In one embodiment, the RRC signaling corresponding to the second information block comprises a SearchSpace IE in TS 38.331.

In one embodiment, the second information block comprises one or more fields in the RRC signaling SearchSpace IE.

In one embodiment, a name of the RRC signaling corresponding to the second information block includes SearchSpace.

In one embodiment, a name of the RRC signaling corresponding to the second information block includes Multi.

In one embodiment, a name of the RRC signaling corresponding to the second information block includes Cells.

In one embodiment, a name of the RRC signaling corresponding to the second information block includes Cross.

In one embodiment, a name of the RRC signaling corresponding to the second information block includes Carrier.

In one embodiment, the second search space comprises a Search Space.

In one embodiment, the second search space comprises a Search Space Set.

In one embodiment, the second search space corresponds to a CORESET.

In one embodiment, K4 is equal to 1.

In one embodiment, K4 is a positive integer greater than 1.

In one embodiment, when the K1 is greater than the K4, the first search space has a higher priority than the second search space during blind detection.

In one embodiment, there is an overlap in the time domain between the time-domain resources occupied by the first search space and the time-domain resources occupied by the second search space.

In one embodiment, the first field in the present application is used to indicate one or more serving cells.

In one embodiment, the step S50 is located before the step S10 in Embodiment 5.

In one embodiment, the step S60 is located before the step S20 in Embodiment 5.

In one embodiment, the step S50 is located before the step S11 and after the step S10 in Embodiment 5.

In one embodiment, the step S60 is located before the step S21 and after the step S20 in Embodiment 5.

In one embodiment, the step S50 is located before the step S30 in Embodiment 6.

In one embodiment, the step S60 is located before the step S40 in Embodiment 6.

In one embodiment, the step S50 is located before the step S31 and after the step S30 in Embodiment 6.

In one embodiment, the step S60 is located before the step S41 and after the step S40 in Embodiment 6.

### Embodiment 8

Embodiment 8 illustrates a schematic of a first information block, as shown in FIG. 8. In FIG. 8, the first information block comprises first information, the first information being a sequence; the first information comprises first sub-information, the first sub-information being enumerated, the first sub-information comprising “formatsXa-And-Ya”; the first sub-information comprises second sub-information, the second sub-information being enumerated, the second sub-information comprising “formatsXb-And-Yb”.

In one embodiment, the “formatsXa-And-Ya” comprised in the first sub-information is used to indicate that DCI Format Xa and DCI Format Ya are capable of size alignment in the first search space.

In one embodiment, the “formatsXb-And-Yb” comprised in the second sub-information is used to indicate that DCI Format Xb and DCI Format Yb are capable of size alignment in the first search space.

In one embodiment, both DCI Format Xa and DCI Format Ya are used for scheduling of multiple serving cells with single DCI.

In one embodiment, both DCI Format Xb and DCI Format Yb are used for scheduling of single serving cell with single DCI.

In one embodiment, the Xa is 4_0 and the Ya is 4_1.

In one embodiment, the Xa is 5_0 and the Ya is 5_1.

In one embodiment, the Xa is 0_4 and the Ya is 1_4.

In one embodiment, the Xa is 0_5 and the Ya is 1_5.

In one embodiment, the Xb is 0_0 and the Yb is 1_0.

In one embodiment, the Xb is 0_1 and the Yb is 1_1.

### Embodiment 9

Embodiment 9 illustrates a schematic diagram of a first search space and a second search space, as shown in FIG. 9. In FIG. 9, time-domain resources occupied by the first search space and time-domain resources occupied by the second search space are overlapped in the time domain.

In one embodiment, the first search space and the second search space are associated to two CORESETs.

In one embodiment, the first search space and the second search space are associated to a same CORESET.

In one embodiment, the first search space is configured for transmission in a format with a single DCI scheduling multiple serving cells.

In one embodiment, the second search space is configured for transmission in a format with a single DCI scheduling a single serving cell.

In one embodiment, the second search space is configured for transmission in a format with a single DCI scheduling multiple serving cells.

### Embodiment 10

Embodiment 10 illustrates a schematic diagram of DCI Size Alignment, as shown in FIG. 10. In FIG. 10, the payload size of a first candidate DCI format is W1 and the payload size of a second candidate DCI format is W2; W1 and W2 are both positive integers greater than 1; the W1 is greater than the W2, and W3 padding bit(s) is/are added to the second candidate DCI format after the W2 bits to achieve the same payload size as the first candidate DCI format, where the W3 is equal to the difference of W1 minus W2.

In one embodiment, the first candidate DCI format is the first DCI format of this application and the second candidate DCI format is the second DCI format of this application.

In one embodiment, the first candidate DCI format is the second DCI format of this application and the second candidate DCI format is the first DCI format of this application.

In one embodiment, the first candidate DCI format is the first DCI format of this application and the second candidate DCI format is the third DCI format of this application.

In one embodiment, the first candidate DCI format is the third DCI format of this application and the second candidate DCI format is the first DCI format of this application.

### Embodiment 11

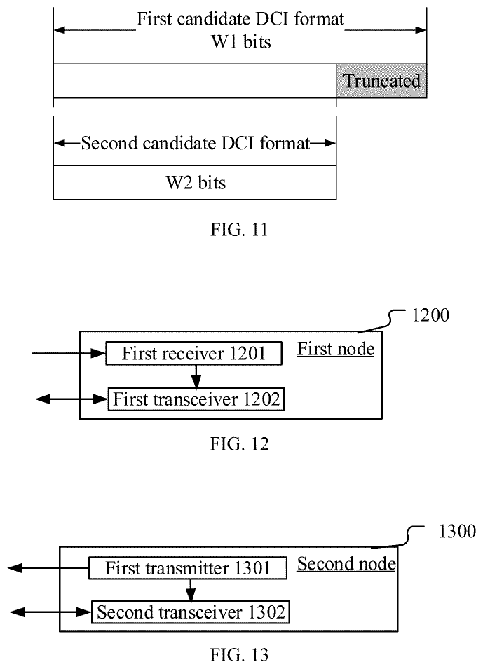

Embodiment 11 illustrates a schematic diagram of DCI Size Alignment, as shown in FIG. 11. In FIG. 11, the payload size of a first candidate DCI format is W1 and the payload size of a second candidate DCI format is W2; W1 and W2 are both positive integers greater than 1; the W1 is greater than the W2, and W3 bit(s) is/are truncated in the first candidate DCI format from the W1 bits to achieve the same payload size as the second candidate DCI format, where the W3 is equal to the difference of W1 minus W2.

In one embodiment, the first candidate DCI format is the first DCI format of this application and the second candidate DCI format is the second DCI format of this application.

In one embodiment, the first candidate DCI format is the second DCI format of this application and the second candidate DCI format is the first DCI format of this application.

In one embodiment, the first candidate DCI format is the first DCI format of this application and the second candidate DCI format is the third DCI format of this application.

In one embodiment, the first candidate DCI format is the third DCI format of this application and the second candidate DCI format is the first DCI format of this application.

### Embodiment 12

Embodiment 12 illustrates a structure block diagram of a first node, as shown in FIG. 12. In FIG. 12, a first node 1200 comprises a first receiver 1201 and a first transceiver 1202.

The first receiver 1201 receives a first information block, the first information block being used to indicate a DCI format monitored in a first search space; and receiving a first DCI in the first search space, the first DCI using a DCI format that is a first DCI format;
the first transceiver 1202 operates a first signal, the first DCI indicating at least one of time-domain resources or frequency-domain resources occupied by the first signal; the operating being receiving, or the operating being transmitting.

In Embodiment 12, a candidate for the DCI format monitored in the first search space includes a first DCI candidate format set; whether the first DCI format is in Size Alignment with a second DCI format is related to whether the first DCI format belongs to the first DCI candidate format set; when the first DCI format belongs to the first DCI candidate format set, the first DCI format is not in Size Alignment with the second DCI format; when the first DCI format does not belong to the first DCI candidate format set, the first DCI format is in Size Alignment with the second DCI format; the second DCI format is a DCI format other than the first DCI candidate format set.

In one embodiment, when the first DCI format belongs to the first DCI candidate format set, the first DCI format is in Size Alignment with a third DCI format, the third DCI format being a DCI candidate format in the first DCI candidate format set.

In one embodiment, a target DCI format is any DCI format in the first DCI candidate format set, and the target DCI format comprises a first field; the first field in the target DCI format is used to determine L1 serving cells, L1 being a positive integer greater than 1.

In one embodiment, the meaning of that the first DCI format is in Size Alignment with the second DCI format includes at least one of:
the first DCI format and the second DCI format being indicated by one field in a same RRC IE; or
the first DCI format and the second DCI format achieving identical payload sizes through padding or truncation.

In one embodiment, characterized in comprising:
the first receiver 1201, receiving a second information block;
herein, the second information block is used to determine a second search space; the first DCI occupies one or more PDCCH candidates in the first search space; the second search space corresponds to a fourth DCI format; the first DCI format comprises the first field, the first field in the first DCI format being used to determine K1 serving cells, K1 being a positive integer greater than 1; the fourth DCI format comprises the first field, the first field in the fourth DCI format being used to determine K4 serving cell(s), K4 being a positive integer; the first DCI format belongs to the first DCI candidate format set; the K1 being greater than the K4 is used to determine that the first node cancels monitoring of a PDCCH in the second search space.

In one embodiment, the frequency-domain resources occupied by the first signal are associated to at least two serving cells.

In one embodiment, the first signal is generated by M1 bit blocks, M1 being a positive integer greater than 1, the M1 bit blocks respectively occupying M1 HARQ process numbers.

In one embodiment, the first information block comprises first information, the first information being a Sequence, the first information comprised in the first information block indicating a DCI format that is capable of size alignment in the first search space.

In one embodiment, the first information block comprises second information, the second information being Enumerated, the second information comprised in the first information block indicating a DCI format that is capable of size alignment in the first search space.

In one embodiment, that the first DCI format is in Size Alignment with the third DCI format includes: the first DCI format and the third DCI format being indicated by one field in a same RRC IE.

In one embodiment, that the first DCI format is in Size Alignment with the third DCI format includes: the first DCI format and the third DCI format achieving identical payload sizes through padding or truncation.

In one embodiment, the first receiver 1201 comprises at least the first four of the antenna 452, the receiver 454, the multi-antenna receiving processor 458, the receiving processor 456 and the controller/processor 459 in Embodiment 4.

In one embodiment, the first transceiver 1202 comprises at least the first six of the antenna 452, the receiver 454, the transmitter 454, the multi-antenna transmitting processor 457, the transmitting processor 468, the multi-antenna receiving processor 458, the receiving processor 456 and the controller/processor 459 in Embodiment 4.

### Embodiment 13

Embodiment 13 illustrates a structure block diagram of a second node, as shown in FIG. 13. In FIG. 13, a second node 1300 comprises a first transmitter 1301 and a second transceiver 1302.

The first transmitter 1301 transmits a first information block, the first information block being used to indicate a DCI format monitored in a first search space; and transmitting a first DCI in the first search space, the first DCI using a DCI format that is a first DCI format;
the second transceiver 1302 executes a first signal, the first DCI indicating at least one of time-domain resources or frequency-domain resources occupied by the first signal; the executing being transmitting, or the executing being receiving.

In Embodiment 13, a candidate for the DCI format transmitted in the first search space includes a first DCI candidate format set; whether the first DCI format is in Size Alignment with a second DCI format is related to whether the first DCI format belongs to the first DCI candidate format set; when the first DCI format belongs to the first DCI candidate format set, the first DCI format is not in Size Alignment with the second DCI format; when the first DCI format does not belong to the first DCI candidate format set, the first DCI format is in Size Alignment with the second DCI format; the second DCI format is a DCI format other than the first DCI candidate format set.

In one embodiment, when the first DCI format belongs to the first DCI candidate format set, the first DCI format is in Size Alignment with a third DCI format, the third DCI format being a DCI candidate format in the first DCI candidate format set.

In one embodiment, a target DCI format is any DCI format in the first DCI candidate format set, and the target DCI format comprises a first field; the first field in the target DCI format is used to determine L1 serving cells, L1 being a positive integer greater than 1.

In one embodiment, the meaning of that the first DCI format is in Size Alignment with the second DCI format includes at least one of:
the first DCI format and the second DCI format being indicated by one field in a same RRC IE; or
the first DCI format and the second DCI format achieving identical payload sizes through padding or truncation.

In one embodiment, characterized in comprising:
the first transmitter 1301, transmitting a second information block;
herein, the second information block is used to determine a second search space; the first DCI occupies one or more PDCCH candidates in the first search space; the second search space corresponds to a fourth DCI format; the first DCI format comprises the first field, the first field in the first DCI format being used to determine K1 serving cells, K1 being a positive integer greater than 1; the fourth DCI format comprises the first field, the first field in the fourth DCI format being used to determine K4 serving cell(s), K4 being a positive integer; the first DCI format belongs to the first DCI candidate format set; the K1 being greater than the K4 is used to determine that the first node cancels monitoring of a PDCCH in the second search space.

In one embodiment, the frequency-domain resources occupied by the first signal are associated to at least two serving cells.

In one embodiment, the first signal is generated by M1 bit blocks, M1 being a positive integer greater than 1, the M1 bit blocks respectively occupying M1 HARQ process numbers.

In one embodiment, the first information block comprises first information, the first information being a Sequence, the first information comprised in the first information block indicating a DCI format that is capable of size alignment in the first search space.

In one embodiment, the first information block comprises second information, the second information being Enumerated, the second information comprised in the first information block indicating a DCI format that is capable of size alignment in the first search space.

In one embodiment, that the first DCI format is in Size Alignment with the third DCI format includes: the first DCI format and the third DCI format being indicated by one field in a same RRC IE.

In one embodiment, that the first DCI format is in Size Alignment with the third DCI format includes: the first DCI format and the third DCI format achieving identical payload sizes through padding or truncation.

In one embodiment, the first transmitter 1301 comprises at least the first four of the antenna 420, the transmitter 418, the multi-antenna transmitting processor 471, the transmitting processor 416 and the controller/processor 475 in Embodiment 4.

In one embodiment, the second transceiver 1302 comprises at least the first six of the antenna 420, the receiver 418, the multi-antenna receiving processor 472, the receiving processor 470, the transmitter 418, the multi-antenna transmitting processor 471, the transmitting processor 414 or the controller/processor 475 in Embodiment 4.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally; all or part of steps in the above embodiments also may be implemented by one or more integrated circuits. Correspondingly; each module unit in the above embodiment may be realized in the form of hardware, or in the form of software function modules. The present application is not limited to any combination of hardware and software in specific forms. The first node in the present application includes but is not limited to mobile phones, tablet computers, notebooks, network cards, low-consumption equipment, enhanced MTC (eMTC) terminals, NB-IOT terminals, vehicle-mounted communication equipment, vehicles, automobiles, RSU, aircrafts, airplanes, unmanned aerial vehicles, telecontrolled aircrafts, etc. The second node in the present application includes but is not limited to macro-cellular base stations, micro-cellular base stations, home base stations, relay base station, eNB, gNB, Transmitter Receiver Point (TRP), GNSS, relay satellite, satellite base station, airborne base station, RSU, unmanned ariel vehicle, test equipment like transceiving device simulating partial functions of base station or signaling tester, and other radio communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first information block, the first information block being used to indicate a DCI format monitored in a first search space; and receiving a first DCI (i.e., Downlink Control Information) in the first search space, the first DCI using a DCI format that is a first DCI format; and
a first transceiver, operating a first signal, the first DCI indicating at least one of time-domain resources or frequency-domain resources occupied by the first signal; the operating being receiving, or the operating being transmitting;
wherein a candidate for the DCI format monitored in the first search space includes a first DCI candidate format set; whether the first DCI format is in Size Alignment with a second DCI format is related to whether the first DCI format belongs to the first DCI candidate format set; when the first DCI format belongs to the first DCI candidate format set, the first DCI format is not in Size Alignment with the second DCI format; when the first DCI format does not belong to the first DCI candidate format set, the first DCI format is in Size Alignment with the second DCI format; the second DCI format is a DCI format other than the first DCI candidate format set.

2. The first node according to claim 1, characterized in that when the first DCI format belongs to the first DCI candidate format set, the first DCI format is in Size Alignment with a third DCI format, the third DCI format being a DCI candidate format in the first DCI candidate format set.

3. The first node according to claim 1, characterized in that a target DCI format is any DCI format in the first DCI candidate format set, and the target DCI format comprises a first field; the first field in the target DCI format is used to determine L1 serving cells, LI being a positive integer greater than 1.

4. The first node according to claim 1, characterized in that the meaning of that the first DCI format is in Size Alignment with the second DCI format includes at least one of:
the first DCI format and the second DCI format being indicated by one field in a same RRC IE; or
the first DCI format and the second DCI format achieving identical payload sizes through padding or truncation.

5. The first node according to claim 1, characterized in comprising:
the first receiver, receiving a second information block;
wherein the second information block is used to determine a second search space; the first DCI occupies one or more PDCCH candidates in the first search space; the second search space corresponds to a fourth DCI format; the first DCI format comprises the first field, the first field in the first DCI format being used to determine K1 serving cells, K1 being a positive integer greater than 1; the fourth DCI format comprises the first field, the first field in the fourth DCI format being used to determine K4 serving cell(s), K4 being a positive integer; the first DCI format belongs to the first DCI candidate format set; the K1 being greater than the K4 is used to determine that the first node cancels monitoring of a PDCCH in the second search space.

6. The first node according to claim 1, characterized in that the frequency-domain resources occupied by the first signal are associated to at least two serving cells.

7. The first node according to claim 1, characterized in that the first signal is generated by M1 bit blocks, M1 being a positive integer greater than 1, the M1 bit blocks respectively occupying M1 HARQ process numbers.

8. The first node according to claim 1, characterized in that an RRC signaling corresponding to the first information block includes a SearchSpace IE in TS 38.331.

9. The first node according to claim 1, characterized in that the first information block is used to indicate multiple DCI formats monitored in the first search space.

10. The first node according to claim 1, characterized in that the first DCI indicates the time-domain resources occupied by the first signal, the frequency-domain resources occupied by the first signal and an MCS occupied by the first signal.

11. The first node according to claim 1, characterized in that the first DCI indicates a TCI (i.e., Transmission Configuration Indication) corresponding to the first signal.

12. The first node according to claim 1, characterized in that the first DCI candidate format set includes Q1 DCI formats, and any one of the Q1 DCI formats is used to indicate multiple serving cells, Q1 being a positive integer greater than 1.

13. The first node according to claim 1, characterized in that the second DCI format is used to schedule one cell, and any DCI format in the first DCI candidate format set is used to schedule multiple cells.

14. The first node according to claim 1, characterized in that any DCI format in the first DCI candidate format set is used to schedule up to N1 cells, N1 being a positive integer greater than 1, N1 being configurable.

15. The first node according to claim 1, characterized in that the first DCI format is used for downlink scheduling and the third DCI format is used for uplink scheduling, or the first DCI format is used for downlink scheduling and the third DCI format is used for downlink scheduling.

16. The first node according to claim 1, characterized in that when the first DCI format is in Size Alignment with the second DCI format; a payload size of the first DCI format is larger than a payload size of the second DCI format, and the second DCI format achieves the same payload size as the first DCI format through padding bits;
or the payload size of the first DCI format is smaller than the payload size of the second DCI format, and the first DCI format achieves the same payload size as the second DCI format through padding bits.

17. The first node according to claim 2, characterized in that when the first DCI format is in Size Alignment with the third DCI format: a payload size of the first DCI format is larger than a payload size of the third DCI format, and the third DCI format achieves the same payload size as the first DCI format through padding bits; or the payload size of the first DCI format is smaller than the payload size of the third DCI format, and the first DCI format achieves the same payload size as the third DCI format through padding bits.

18. The first node according to claim 2, characterized in that the first signal comprises K1 sub-signals, and the K1 sub-signals are respectively transmitted on K1 serving cells, the first DCI is used to indicate the K1 serving cells, and the first DCI comprises K1 fields, the K1 fields respectively corresponding to the K1 sub-signals.

19. A second node for wireless communications, comprising:
a first transmitter, transmitting a first information block, the first information block being used to indicate a DCI format monitored in a first search space; and transmitting a first DCI in the first search space, the first DCI using a DCI format that is a first DCI format; and
a second transceiver, executing a first signal, the first DCI indicating at least one of time-domain resources or frequency-domain resources occupied by the first signal; the executing being transmitting, or the executing being receiving;
wherein a candidate for the DCI format monitored in the first search space includes a first DCI candidate format set; whether the first DCI format is in Size Alignment with a second DCI format is related to whether the first DCI format belongs to the first DCI candidate format set; when the first DCI format belongs to the first DCI candidate format set, the first DCI format is not in Size Alignment with the second DCI format; when the first DCI format does not belong to the first DCI candidate format set, the first DCI format is in Size Alignment with the second DCI format; the second DCI format is a DCI format other than the first DCI candidate format set.

20. A method in a first node for wireless communications, comprising:
receiving a first information block, the first information block being used to indicate a DCI format monitored in a first search space; and receiving a first DCI in the first search space, the first DCI using a DCI format that is a first DCI format; and
operating a first signal, the first DCI indicating at least one of time-domain resources or frequency-domain resources occupied by the first signal; the operating being receiving, or the operating being transmitting;
wherein a candidate for the DCI format monitored in the first search space includes a first DCI candidate format set; whether the first DCI format is in Size Alignment with a second DCI format is related to whether the first DCI format belongs to the first DCI candidate format set; when the first DCI format belongs to the first DCI candidate format set, the first DCI format is not in Size Alignment with the second DCI format; when the first DCI format does not belong to the first DCI candidate format set, the first DCI format is in Size Alignment with the second DCI format; the second DCI format is a DCI format other than the first DCI candidate format set.
